(19) United States
(12) Patent Application Publication
(10) Pub. No.: US 2026/0215414 A1
(43) Pub. Date: Jul. 30, 2026

(54) COMPOSITION

(71) Applicant: SYNGENTA CROP PROTECTION AG, Basel (CH)

(72) Inventors: Nicholas Jonathan William PENFOLD, Bracknell, Berkshire (GB); Jacek Jan DRZEWIECKI, Bracknell, Berkshire (GB)

(73) Assignee: SYNGENTA CROP PROTECTION AG, Basel (CH)

(21) Appl. No.: 19/141,790

(22) PCT Filed: Dec. 14, 2023
(86) PCT No.: PCT/EP2023/085742

§ 371 Date: Jun. 20, 2025

(30) Foreign Application Priority Data
Dec. 21, 2022 (GB) 2219437.7

(51) Int. Cl. A01N 25/04; A01P 15/00

(52) U.S. Cl. CPC A01N 25/04; A01P 15/00

(57) ABSTRACT

A liquid tank mix composition comprising: a polysaccharide; a carrier fluid; and a thickening agent, wherein the one or more polysaccharides are present in an amount of at least 10% by weight wherein the carrier fluid is a low polarity oil, and wherein the thickening agent is a clay and/or a silica.

### COMPOSITION

The present invention relates to a composition for polysaccharide delivery and methods of preparation and use thereof.

Agrochemicals are biologically active materials such as herbicides, fungicides and insecticides used by farmers and growers to control weeds and insect and fungal pests in, on, or around their crops. Typically, agrochemicals are supplied as a concentrate which is diluted with water before application to form the final composition to be applied. In recent times it has been recognised that for some applications it could be advantageous to use a more targeted application of agrochemical, rather than evenly covering an entire area such as a field. For all types of agrochemical, it could also allow the use of a much lower average level of agrochemical across the field as a whole, lowering costs for the farmer and lowering the amount of agrochemical in the environment. This targeted spray application is known as ‘precision application’.

‘Precision application’ is defined as the application of agrochemicals to discrete parts of the target location rather than the entire area (broadcast application). Types of precision application include, but are not limited to, hooded/banded application, variable rate application using prescription maps and optical spot spraying. Precision application also includes this type of targeted application in non-row crop type applications, such as in-furrow application or orchard spraying.

Accordingly, it has been discovered that polysaccharides in agrochemical compositions can provide enhanced spray retention in precision application scenarios. The polysaccharide concentration in the spray solution is typically around 0.1 (w/w) and spray solutions can be prepared at a lab scale simply by the diluting of an aqueous pre-gel (1-2% w/w).

However, this dilution factor is unsuitable on a commercial scale. For example, 1000 L spray tank would require a 50 L of a 2% aqueous pre-gel, a dilution factor of 20, which is commercially unsuitable. The technical problem is therefore how to effectively deliver polysaccharide polymers into a spray tank for their ultimate use in agrochemical applications.

There is therefore provided a liquid tank mix composition comprising:
a. a polysaccharide;
b. a carrier fluid; and
c. a thickening agent,
wherein the one or more polysaccharides are present in an amount of at least 10% by weight,
wherein the carrier fluid is a low polarity oil, and
wherein the thickening agent is a clay and/or a silica.

The compositions according to the invention therefore provide a concentrated liquid formulation product that can be applied as a ‘tank-mix’. By ‘tank mix’ we mean a composition that is intended to be mixed with water in an agrochemical spray tank. Such a tank mix composition typically does not contain an agrochemical but is mixed with a composition containing an agrochemical in the spray tank.

Preferably the formulation is an oil dispersion (OD). An oil dispersion is a dispersion of solid particles in a suitable organic carrier liquid.

Compositions according to the invention have been found to show improved physical stability, such as showing negligible separation on storage, while retaining flowability. By negligible separation we mean less than or equal to 10% visual separation after 2 weeks (or even 4 weeks) at 25° C.

It has been found that such a physically stable composition forms, when diluted directly in water, a suitably thickened spray solution. The oil dispersion thus acts as a convenient delivery vehicle for the polysaccharide into water.

The composition may comprise no or substantially no active ingredient.

### Polysaccharide

Advantageously, the one or more polysaccharides are selected from diutan gum, guar gum, cellulose, or derivatives thereof.

Advantageously, the one or more polysaccharides are present in an amount of at least 12% by weight, such as at least 13% by weight, or at least 14% by weight.

Preferably the polysaccharide is present in an amount of from 12 to 60% by weight, even more preferably from 15 to 55% by weight.

Having a polysaccharide concentration in this range significantly increases the dilution factor (e.g., a 40% w/w concentration will require only 2.5 L of product for a 1000 L spray tank and thus a dilution factor of 400).

### Carrier Fluid

The carrier fluid may be any non-aqueous liquid which possesses the desired non-solvent characteristics for the solid to be dispersed in the fluid. The carrier fluid is preferably an organic fluid, advantageously a low polarity oil.

A low polarity fluid (such as an oil) is a fluid that has a dielectric constant less than 2.5.

The suspended polysaccharide should be insoluble or essentially insoluble in the carrier fluid, such as having a solubility of up to 700 ppm, preferably up to 500 ppm.

Hydrocarbons are often a suitable carrier fluid. For example, the low polarity oil may be a paraffinic or mineral oil. Suitable organic media include mineral spirits, mineral oils, aliphatic compounds, hexane, heptane, and white spirit. Suitably the liquid is a mineral oil such as Sunspray 11N®. Preferably the carrier fluid is a low polarity organic liquid, such as the commercially available paraffinic oil Sunspray 11N®.

Carrier fluids with higher dielectric constants may be employed if the polysaccharide is insoluble in that fluid. Advantageously, such liquids of greater polarity may also have higher water solubilities, enabling a more rapid dissolution of the solid on addition to water. Examples are, for example, methylated rape seed oil, oleic acid, dipropylene glycol dibenzoate or Solvesso® 200.

The carrier fluid is preferably present in an amount of from 20 to 90% by weight, such as from 30 to 80% by weight, from 35 to 70% by weight, or even from 40 to 60% by weight.

The composition preferably contains less than 10% by weight of water, such as less than 5% by weight, less than 1% by weight or even less than 0.5% by weight.

### Thickening Agent

To stabilise a dispersion of solid polysaccharides against sedimentation in a carrier fluid requires the use of one or more thickening agents. The thickening agent may be an inert solid particle. Preferably the thickening agent is a clay, such as one or more organoclays.

Advantageously the thickening agent is present in an amount of from 0.001-5% by weight, such as from 0.01 to 3% by weight, or from 0.1 to 2% by weight.

Natural clays, such as montmorillonites, attapulgites and illites, which exhibit substantial base-exchange capacities, may be modified and rendered hydrophobic by treatment with long chain amines. These are referred to as organoclays. Organoclays may be made from natural attapulgite, smectite, hectorite or montmorillonite clays.

Any suitable organoclay thickening agent may be used in the present invention.

The organoclay thickening agent used in the present invention may be selected from the group consisting of organically modified bentonite, hectorite and smectite clays, for example tetraalkyl ammonium bentonite (for example Bentone™ 34), tetraalkyl ammonium hectorite (for example Bentone™ 38), tetra(alkyl/aryl) ammonium bentonite (for example Bentone™ SD-1, Bentone™ 52, Bentone™ 120, and Bentone™ 1000), alkyl-aryl ammonium hectorite (for example Bentone™ SD-3). Suitably, the organoclay thickening agent is selected from the group consisting of tetraalkyl ammonium bentonite, tetraalkyl ammonium hectorite and tetra(alkyl/aryl) ammonium bentonite. Suitably, the organoclay thickening agent is tetraalkyl ammonium bentonite. Suitably, the organoclay stabiliser is tetraalkyl ammonium hectorite. Suitably, the organoclay stabiliser is tetra(alkyl/aryl) ammonium bentonite.

The thickening agent, if a clay, may be activated prior to its inclusion. The terms ‘activator’ and ‘activating’ refer to the formation of a gel structure in the clay. The activating substance may be present in an amount of from 0.3 to 10% by weight.

The chemical or polar activator may help to both disperse the (organo) clay and to function as an anti-settling system with good gel strength and physical stability. The term polar activator refers to a molecule that is capable of activating the organoclay stabiliser so that it forms a gel structure. For example, methanol, propylene carbonate and water.

It was found that the clay may be activated either in situ or before addition to the composition, preferably before addition. Examples of amine salts which were used to modify the clay were salts of isopropylamine, cyclohexylamine and methylcyclohexyl amine, such as the bromides and acetates. When the clay was modified by treatment with an amine salt it is preferable to incorporate an anionic surfactant into the composition. This anionic surfactant could be neutralised with a suitable amine such as an alkyl C10 amine or a cycloalkylamine or an alkylcycloalkyl amine. Particularly preferred were alkylarylsulphonates such as alkylbenzenesulphonates and alkylnapthalenesulphonates. More particularly preferred were isopropylamine, cyclohexylamine and methylcyclohexylamine salts of alkylbenzenesulphonates.

The degree of activation of organoclay can be correlated with clay gel strength and physical stability as the amount of gelling in the system can be controlled by varying the proportions of the clay and the amine neutralized surfactant and also by the replacement of a portion of the amine neutralized anionic surfactant with an appropriate amount of a conventional anionic surfactant such as an alkali metal or alkaline earth metal salt of the anionic surfactant. The gelling should be sufficient to maintain the substantially insoluble solid component in suspension without rendering the composition too thick for use.

Such formulations may be produced by any conventional wet-milling process which would produce a satisfactory particle size reduction in the solid materials. Examples are sand-mills and bead-mills. Alternatively, the solid material may be dry-milled prior formulating into a mix of pre-gelled material. Alternatively, active material of a suitable particle size may be dispersed by high shear equipment into a mix of pre-gelled material.

Clays suitable for use with low polarity organic systems can be activated by certain emulsifiers instead of polar species. In these situations, activation by emulsifiers can result in anti-settling systems that have better physical stability and/or extended storage stability compared to activation using a polar activator. Further, the addition a glycol ether can improve physical stability of the dispersion. Any suitable glycol ether may be used but preferably include Dowanol PnB, propylene glycol, and n-monobutyl ether. The ratio of glycol ether to organoclay stabiliser may be between 100:1 to 1:100 by weight, preferably from 10:1 to 1:10 w/w. Such as about 2:1 w/w. The glycol ether may be added in addition to or instead of the polar activator.

An organoclay thickening agent that is suitable for use with a low polarity liquid is an organically modified attapulgite, hectorite, smectite, bentonites or montmorillonite clay. The clay is preferably organically modified to make it organophilic and suitable for use in organic media.

Also suitable thickening agents are silicas, preferably a fumed silica (e.g., Cab-O-Sil), or a precipitated silica (Sipernat 50™); aluminium stearate; and/or a hydrogenated oil.

Moreover, mixtures of these thickening agents may be used, advantageously the composition may comprise a clay and a silica. An example of this would be a mixture of Bentone with a silica (e.g., in a ratio of 3:1 to 1:3).

### Emulsifiers

Emulsifiers may be added to the formulations of the present invention. The term ‘emulsifier’ is herein used to include all forms of surfactants (e.g., anionic, nonionic and zwitterionic).

Emulsifiers are employed in the composition to emulsify a water insoluble organic liquid and facilitate the release of the dispersed solid into the aqueous phase to that it efficiently and speedily develops its desired rheological properties. Therefore, the emulsifier may aid this process. In principle, any emulsifier can be used.

The use of such emulsifiers may also activate the organoclay thickening agent. Such emulsifiers could include alkyl ethoxylates, alkyl ethoxylate phosphate esters, alkyl sulphates, alkyl ammonium salts and castor oil ethoxylates.

Anionic surfactants may be employed as part of the gel system (described above) and are conventionally balanced in with non-ionic surfactants to provide optimal emulsification of such formulations over a wide range of conditions of use. Suitable non-ionic surfactants which may be included in the compositions of the invention are the condensation products of fatty acid esters, fatty alcohols, fatty acid amides or fatty acid amines condensed with ethylene and/or propylene oxide, alkyl-, alkenyl, or polyaryl-substituted phenols with ethylene and/or propylene oxide, fatty esters of polyhydric alcohol ethers e.g., sorbitan fatty acid esters, condensation products of such esters with ethylene oxide e.g., polyoxyethylene sorbitan fatty acid esters, block copolymers of ethylene oxide and propylene oxide, ethoxylated lanolin alcohols or ethoxylated lanolin acids.

### Advantageously the Emulsifier is Emulsogen M®.

The emulsifier may be present in an amount of from 0.5 to 30% by weight, such as from 0.6 to 25% by weight, from 0.7 to 20% by weight, from 0.8 to 15% by weight, or even from 1 to 10% by weight.

### Composition and Use

There is also provided a composition comprising an active ingredient, water and a composition as described herein, which advantageously exhibit reduced shatter. Preferably the polysaccharide is present in an amount of from 0.001 to 1% by weight.

‘Droplet shatter’ is defined as the break-up of a primary liquid droplet(s) of nominal diameter upon impact with a surface, that subsequently results in a higher number of smaller, secondary droplets which fall outside the area of initial impact. ‘Shatter reduction’ is accordingly defined as percentage reduction in total number of secondary droplets due to a change in the composition or in comparison to a reference composition

The terms ‘agrochemical’ and ‘active ingredient’ are used interchangeably and include herbicides, fungicides and insecticides used by farmers and growers to control weeds and insect and fungal pests in, on, or around their crops.

There is also provided a precision application device in combination with the shatter-reducing composition described above.

There is provided a method of preparing a composition as described herein, preferably comprising the high shear mixing of polysaccharide solids with a suitable carrier fluid and thickening system under high shear mixing. Suitable high shear mixing can be provided equipment is familiar to those skilled in the art, such as IKA overhead mixers and wet bead-mills. Advantageously, this method is carried out at a temperature of from 10 to 80° C.

There is also provided the use of a composition as described herein as a tank mix to reduce the shatter of an agrochemical composition. Preferably, the compositions as described herein are used in a precision agriculture application.

Unless otherwise stated, percentages are given as percentages by total weight and all embodiments and preferred features may be combined in any combination.

The invention is described by the following non-limiting Examples.

### EXAMPLES

The definitions of relevant components are set out in Table 1.

TABLE 1
Polysaccharide

| | |
|---|---|
| KELCO-VIS DG | Diutan Gum |
| Akucell AF 3285 | carboxymethyl cellulose ether. |
| Jaguar S | native guar gum |
| Jaguar HP 60 | Hydroxypropyl guar gum |
| PPEM 9575 | Cellulose ethers, -ethyl and -hydroxyethyl modified |
| PPEM 9578 | Cellulose ethers, -ethyl and -hydroxyethyl modified |

Thickeners

| | |
|---|---|
| Bentone 38 | organic derivative of a hectorite clay |
| Sipernat 50 | Silicon dioxide |

Emulsifiers

| | |
|---|---|
| Emulsogen M | fatty alcohol ethoxylate |

Carrier Fluids

| | |
|---|---|
| Sunspray 11N | Mixture of petroleum extracts |

Preparation of Bentone 38 pre-gel in Sunspray 11N

A pre-gel of the thickening agent and carrier fluid was prepared as per below.

A pre-gel of 1.5% w/w Bentone 38 in Sunspray 11N was prepared using a temperature-controlled 500 mL vessel fitted with a Silverson high shear mixer charged with Sunspray 11N (174 g) and mixed at 4000 rpm at 25° C.

Bentone 38 (3.04 g) was added and mixed at 25° C. for 10 minutes. Propylene carbonate (0.30 g) was added and mixed at 25° C. for 10 minutes. Finally, Emulsogen M (22.8 g) was added and mixed at 7500 rpm for a further 10 minutes, before cooling to 20° C.

Unless otherwise stated, formulations comprising Bentone 38 and Sunspray 11N use this pre-gel with the stated level of dilution.

### Assessment of Physical Stability of Oil Dispersions

Visual inspection of polysaccharide oil dispersions is performed with respect to certain storage criteria, typically at 25° C. The separation % is judged by visual inspection.

Preparation of KELCO-VIS Oil Dispersions at 40% w/w with Bentone 38

A 50 mL vessel fitted with an IKA overhead mixer and sawtooth paddle was charged with Sunspray 11N (13.5 g) and mixed at 600 rpm. Bentone 38 1.5% w/w pre-gel (16.5 g) was added and mixed for 5 minutes. KELCO-VIS DG (20.0 g) powder was added over 10 minutes and mixed at 800 rpm for a further 15 minutes.

This procedure is exemplified for Diutan Gum at 40% w/w and is used for the preparation of various polysaccharides oil dispersions described in examples 1A to 1E, 2A-2D and 3A-3F as set out in Tables 2 and Table 3.

Table 2 shows the separation % after 2 weeks at 25° C. for Diutan Gum slurries. In all cases the carrier fluid is Sunspray 11N, the thickening agent is Bentone 38 and the polysaccharide is Diutan gum. For all entries the ratio of Bentone 38: Emulsogen M is 1:7.5.

TABLE 2

| | Polysaccharide | Thickening Agent | |
|---|---|---|---|
| | concentration | concentration | Separation (%) after |
| Example | (% w/v) | (% w/v) | 2 weeks at 25° C. |
| 1A | 20 | 0.5 | 13 |
| 1B | 20 | 1.0 | 8 |
| 1C | 30 | 0.5 | 37 |
| 1D | 40 | 0.5 | 2 |
| 1E | 40 | 1.0 | n/a (paste) |

It can therefore be seen that optimisation of the thickening agent quantity is required to maintain physical stability whilst still ensuring flowable properties. For instance, 1B and 1D are physically stable yet flowable compositions. In contrast, Examples 1A and 1C slow that physical stability has not been achieved whilst 1E demonstrate that too much thickening agent results in formation of a non-flowable paste.

Preparation of KELCO-VIS Oil Dispersions at 40% w/w with Bentone 38 and Sipernat 50

A 50 mL vessel fitted with an IKA overhead mixer and sawtooth paddle was charged with Sunspray 11N (13.25 g) and mixed at 600 rpm. Bentone 38 1.5% w/w pre-gel (16.5 g) was added and mixed for 5 minutes. SIPERNAT 50 (0.25 g) was added and mixed for 5 minutes. KELCO-VIS DG (12.1 g) powder was added over 10 minutes and mixed at 800 rpm for a further 15 minutes. This procedure is exemplified for Diutan Gum at 40% w/w and is used for the preparation of various polysaccharides oil dispersions described in examples 3G-3L shown in Table 3.

Table 3 shows the separation % after 4 weeks at 25° C. for various polysaccharide compositions. For all entries, the polymer concentration is 40%, Emulsogen M is 3.75%, Bentone 38 is 0.50% or Bentone 38 (0.50%) and Sipernat 50 (0.50%), and Sunspray 11N as the carrier fluid.

TABLE 3

| | | | Separation |
|---|---|---|---|
| Example | Polysaccharide | Thickener System | (%) |
| 3A | Akucell AF | Bentone 38 | 20 |
| | 3285 | | |
| 3B | Diutan Gum | Bentone 38 | 8 |
| 3C | Jaguar HP60 | Bentone 38 | 20 |
| 3D | Jaguar S | Bentone 38 | 11 |
| 3E | PPEM 9575 | Bentone 38 | 8 |
| 3F | PPEM 9578 | Bentone 38 | 7 |
| 3G | Akucell AF | Bentone 38 + SIPERNAT 50 | 9 |
| | 3285 | | |
| 3H | Diutan Gum | Bentone 38 + SIPERNAT 50 | 9 |
| 3I | Jaguar HP60 | Bentone 38 + SIPERNAT 50 | 6 |
| 3J | Jaguar S | Bentone 38 + SIPERNAT 50 | 5 |
| 3K | PPEM 9575 | Bentone 38 + SIPERNAT 50 | 13 |
| 3L | PPEM 9578 | Bentone 38 + SIPERNAT 50 | 14 |

As seen in Table 3, various polysaccharides can be formulated as physically stable oil dispersions by selecting a suitable thickener system.

Dilution of Polysaccharide Oil-Dispersions into Water

Example 4A was prepared as follows: Diutan Gum (10 g) was mixed with deionized water (990 g) under high shear mixing for 20 minutes to afford a 1% aqueous pre-gel. 10 g of this 1% w/w pre-gel was mixed with 90 g of deionized water to afford a 0.10% Diutan Gum aqueous solution.

Example 4B was prepared by pipetting 0.50 g of 1B into water (99.50 g) under gentle stirring using a magnetic stirrer bar. The formulation is left for 5 minutes to allow the polysaccharide particles to hydrate and thicken the aqueous fluid.

Example 4C was prepared by pipetting 0.25 g of 1D into water (99.75 g) under gentle stirring using a magnetic stirrer bar. The formulation is left for 5 minutes to allow the polysaccharide particles to hydrate and thicken the aqueous fluid.

Table 4 presents the shear viscosity data for aqueous solutions of Diutan Gum (0.10%) prepared using either a 1% Diutan Gum aqueous pre-gel or examples 1B and 1D.

TABLE 4

| | | Dilution | | | |
|---|---|---|---|---|---|
| | Starting | DG | | | |
| | Diutan Gum | Content | Shear Rate (mPa · s) | | |
| Examples | Concentration | (% wt) | 10 s⁻¹ | 20 s⁻¹ | 300 s⁻¹ |
| 4A | 1% aqueous pre-gel | 0.10 | 130 | 69 | 9 |
| 4B (1B) | 20% oil dispersion | 0.10 | 118 | 63 | 9 |
| 4C (1D) | 40% oil dispersion | 0.10 | 130 | 70 | 10 |

Table 4 demonstrates that the final aqueous solution containing diutan gum (0.10%) exhibits the same rheological properties, regardless of the preparation method via the previously adopted dilution of a wholly-aqueous pre-gel (example 4A) or a polysaccharide oil dispersion according to the invention (examples 4B and 4C).

### Assessment of Spray Retention Performance

Spray solutions were prepared by mixing fully the required composition as defined in the Tables below. In all cases the balance to 100% by weight is water.

Sulfacid Blue 5J was introduced to the spray solution at a final concentration of 0.5% w/w.

### Spray Assessments

To assess the effectiveness of polysaccharides in reducing the shatter of compositions, a bespoke spray assessment method was developed. A custom-built static spray rig was built and is equipped with a jetting nozzle operating at 3.0±0.1 bar. Placed 10 cm below the nozzle tip is the target surface, unless specified otherwise, is a circular synthetic fabric substrate (D=20 mm) on a cylindrical support (20 mm×80 mm). This surface has a contact angle of 133±2° with deionised water and is used to replicate difficult-to-wet foliage.

Formulations were loaded into the spray rig and the operating parameters were adjusted to ensure a 14±1 mg dose of spray solution was applied to the target. Located below the supported target surface is a sheet of A4 paper used to capture non-retained spray, with visualisation aided by the blue dye. A total of 10 spray events (e.g., 10 repeats on 10 sheets of paper) were collected for each spray scenario.

Shatter performance was assessed in following manner. The 10 A4 capture sheets were digitalised using a Brother DS-720D scanner operating at 600 dpi. Subsequently, the digitalised data was analysed using a bespoke ImageJ macro to collate information on droplet number, coordination, and area. Performance was assessed by analysis of the total droplet number, where the shatter reduction is characterised by a percentage reduction in total droplet number.

Example 5A is prepared as follows. The Bentone 38 1.5% pre-gel in Sunspray 11N (0.25 g) is pipetted into deionized water (99.25 g) and mixed gently for 5 minutes. Sulfacid blue 5J (0.50 g) is added and mixed for a further 5 minutes before spraying.

Example 5B-D were prepared by pipetting 0.25 g of 3B, 3I or 3E into water (99.25 g) under gentle stirring using a magnetic stirrer bar. The formulation is left for 5 minutes to allow the polysaccharide particles to hydrate and thicken the aqueous fluid. Sulfacid Blue 5J (0.50 g) was added under gentle mixing for a further 5 minutes

Table 5 presents the data summary for the spray assessment of various polysaccharides oil dispersions. Each spray solution was prepared by diluting a 40% polysaccharide oil dispersion in water to a final concentration of 0.10%. Control (5A) is the oil dispersion formulation without any polysaccharide present.

TABLE 5

| Example | Formulation | Total Droplet Number | Reduction % |
|---|---|---|---|
| 5A | Control | 2433 | — |
| 5B (3B) | Diutan Gum | 9 | 99.3 |
| 5C (3I) | Jaguar HP 60 | 3 | 99.9 |
| 5D (3E) | PPEM 9575 | 11 | 99.5 |

Table 5 demonstrates that each of the polysaccharide oil dispersions of the invention, once diluted into water, are capable of providing the desired significant reduction in the total droplet number (i.e., reduction of greater than 50%, preferably greater than 85% reduction), and thus can be to reduce the shatter of spray droplets of agrochemical compositions upon impact with surfaces.

It can therefore be seen that the compositions of the present invention provide concentrated and stable polysaccharide formulations, which are suitable for precision agriculture applications (among others).

The invention is defined by the claims.

1. A liquid tank mix composition comprising:
a. a polysaccharide;
b. a carrier fluid; and
c. a thickening agent,
wherein the one or more polysaccharides are present in an amount of at least 10% by weight, wherein the carrier fluid is a low polarity oil, and
wherein the thickening agent is a clay and/or a silica.

2. A composition according to claim 1 which is an oil dispersion (OD).

3. A composition according to claim 1, wherein the polysaccharide is present in an amount of from 15 to 55% by weight.

4. A composition according to claim 1, wherein the one or more polysaccharides are selected from diutan gum, guar gum, cellulose, or derivatives thereof.

5. A composition according to claim 1, wherein the composition comprises less than 10% by weight of water.

6. A composition according to claim 5, wherein the low polarity oil is a mineral oil.

7. A composition according to claim 1, wherein the thickening agent is a clay and a silica.

8. A composition according to claim 1, wherein the thickening agent is present in an amount of from 0.001 to 5% by weight.

9. A composition according to claim 1 comprising (d) an emulsifier.

10. A composition according to claim 9, wherein the emulsifier is present in an amount of from 1 to 10%.

11. A composition comprising an active ingredient, water and a composition according to claim 1, which exhibits reduced shatter.

12. A composition according to claim 11, wherein the polysaccharide is present in an amount of from 0.001 to 1% by weight.

13. A precision application device and a composition according to claim 11.

14. A method of preparing a composition according to claim 1 comprising the high shear mixing of the components.

15. Use of a composition according to claim 1 as a tank mix to reduce the shatter of an agrochemical composition.
